(19) United States
(12) Patent Application Publication
(10) Pub. No.: US 2008/0259034 A1
(43) Pub. Date: Oct. 23, 2008

(54) OPTICAL POINTING DEVICE AND METHOD FOR CALCULATING MOTION VALUE IN THE SAME

(75) Inventors: BANG-WON LEE, Yongin-si (KR); WOO-SEOK LEE, Yongin-si (KR); JONG-TAEK KWAK, Seongnam-si (KR); WAN-GYO JEONG, Seongnam-si (KR)

Correspondence Address: CANTOR COLBURN, LLP, 20 Church Street, 22nd Floor, Hartford, CT, 06103, US

(73) Assignee: ATLab Inc., Yongin-si (KR)

(21) Appl. No.: 12/127,664

(22) Filed: May 27, 2008

(30) Foreign Application Priority Data
Apr. 11, 2007 (KR) 10-2007-0035501

(51) Int. Cl. G06F 3/02

(52) U.S. Cl. 345/166

(57) ABSTRACT

The optical pointing device of the present invention includes a light source for emitting light; a mode identifier for outputting an upside-down mode signal when the optical pointing device is used upside-down; an image sensor for receiving reflected light from an object and obtaining image information of the object; a converter for converting the image information into digital image data; a basic motion value calculator for outputting a basic motion value corresponding to a motion of the optical pointing device using the image data; and a motion value converter for receiving the basic motion value and outputting a mirror motion value corresponding to the motion of the object in response to the upside-down mode signal. Thus, the optical pointing device provides the rotation mode, the upside-down mode and the normal mode, so that the optical pointing device is used in various situations and upside-down.

### BACKGROUND OF THE INVENTION

1. Field of the Invention

The present invention relates to an optical pointing device and a method for calculating a motion value in the optical pointing device, and more particularly, to an optical pointing device that outputs the same motion information as a motion of an object when the optical pointing device is used upside-down, and a method for calculating a motion value in the optical pointing device.

2. Description of the Related Art

An optical pointing device continuously obtains images reflected from an object (or a worktable) by irradiating a surface of the object with light, and compares a previously obtained image with a currently obtained image to calculate a motion value.

FIG. 1 illustrates an optical mouse that is one example of a typical optical pointing device. The optical mouse includes a controller 10, an input unit 20, and a light source 30. The controller 10 includes an image data output unit 11 including an image sensor 11-1 and a converter 11-2; a motion value calculator 12; and a communication unit 13. In FIG. 1, a lens delivers reflected light from a working surface to the image sensor 11-1. A dotted line of FIG. 1 indicates an irradiation direction of the light from the light source 30 to the image sensor 11-1.

Respective functions of the blocks shown in FIG. 1 will now be described.

The controller 10 senses the image of the bottom, calculates a motion value, and outputs motion information INF to an external device, such as a computer, according to an input signal from the input unit 20 and the calculated motion value.

The image data output unit 11 senses the image of the object and outputs image data for the sensed image. In the image data output unit 11, the image sensor 11-1 receives the reflected light from the working surface via the lens, senses image information, and outputs an analog signal corresponding to the sensed image information. The converter 11-2 converts the analog signal from the image sensor 11-1 into digital data, and outputs the digital data as the image data.

The motion value calculator 12 calculates and outputs a motion value using the image data input from the converter 11-2. The motion value calculator 12 outputs an illumination signal for controlling the light source 30 in response to a state of the optical mouse and a signal input from the communication unit 13.

The communication unit 13 outputs information (e.g., an operation state of buttons and a motion of a scroll device) input via the input unit 20 to the motion value calculator 12 in response to an input signal from the input unit 20, and outputs the motion information INF to the external device, such as a computer, in response to the motion value from the motion value calculator 12 and the input signal from the input unit 20.

The input unit 20 may consist of, for example, the buttons or the scroll device. The input unit 20 outputs the input signal according to a user's operation. The light source 30 turns on or off in response to the illumination signal from the motion value calculator 12 and radiates light onto the working surface. The light source 30 may consist of, for example, a light emitting diode and a driving circuit for turning the light emitting diode on or off.

The optical pointing device is widely used as an input device for a computer. For convenience of use, the optical pointing device and a keyboard are generally laid side by side. A typical keyboard has an X-axis longer than a Y-axis, and a moving area of the optical pointing device for moving a cursor on a monitor screen has an X-axis longer than a Y-axis. Accordingly, the X-axis length of the keyboard and the moving area of the optical pointing device are longer than that of the monitor screen.

For convenience of use, the optical pointing device is laid to protrude from the right of the keyboard in order to match eyes of a user with a center of his or her finger. This arrangement of the keyboard and the optical pointing device occupies a large area in an X-axis direction.

This causes inconvenience to a user who uses a computer in a limited area, such as a train or an airplane, that is, limits the moving area of the optical pointing device.

FIG. 2 is a block diagram illustrating a conventional optical pointing device proposed for resolving the aforementioned problems. Only a portion of the optical pointing device shown in FIG. 1 is shown.

The optical pointing device of FIG. 2 limits an area for reading from an image sensor, if necessary. The image sensor 21-1 includes a pixel array in which the number (e.g., 12) of pixels constituting an X-axis is equal to the number (e.g., 12) of pixels constituting a Y-axis, and changes a motion search range 21-1a in response to a control signal from the motion value calculator 22.

That is, the image sensor 21-1 activates only pixels corresponding to the specific area 21-1a in response to column and row select signals and a pixel control signal from the motion value calculator 22, senses image information through the activated pixels, generates an analog signal corresponding to the sensed image information, and outputs the same to the converter 21-2.

Here, the column select signal activates the Y-axis of the image sensor 21-1 and the row select signal activates the X-axis of the image sensor 21-1. The pixel control signal determines a start address of the image sensor 21-1, and the image sensor 21-1 determines a start points of the motion search range 21-1a as shown in FIGS. 3 and 4 in response to the pixel control signal.

The converter 21-2 converts analog signals from the respective pixels of the image sensor 21-1 into digital image data and outputs the same to the motion value calculator 22.

The motion value calculator 22 determines directions of the X-axis and the Y-axis of the motion search range in response to an output signal of a light source location sensor 40, generates the column and row select signals and the pixel control signal for activating the specific area 21-1a of the image sensor corresponding to the determined motion search range, and sends the same to the image sensor 21-1.

When the image data output unit 21 outputs image data in response to the column and row select signals and the pixel control signal, the motion value calculator 22 compares image data obtained during a current sampling period with image data obtained during a previous sampling period to calculate the motion value of the optical pointing device.

The light source location sensor 40 recognizes a layout of the image sensor 21-1 and the light source of the optical pointing device, and sends the layout information to the motion value calculator 22.

When the image sensor 21-1 and the light source 30 of the optical pointing device are arranged to be parallel with the Y-axis of the optical pointing device as shown in FIG. 3, the X-axis and Y-axis directions of the motion search range are determined so that an actual moving direction of the optical pointing device matches with a recognized moving direction of the optical pointing device. The motion search range has an X-axis length (12 pixels) longer than a Y-axis length (9 pixels).

However, when the image sensor 21-1 and the light source 30 of the optical pointing device are arranged to be in parallel with the X-axis of the optical pointing device as shown in FIG. 4, the X-axis and Y-axis directions of the motion search range are determined so that the actual moving direction of the optical pointing device is orthogonal to the recognized moving direction of the optical pointing device. The motion search range has an X-axis length (9 pixels) shorter than a Y-axis length (12 pixels).

That is, the X-axis and the Y-axis of the actual motion and the recognized motion of the optical pointing device are interchanged, such that when the optical pointing device actually moves on the X-axis, the optical pointing device is recognized as moving in the Y-axis direction.

The X-axis and the Y-axis of the optical pointing device and the image sensor 21-1 are interchanged and recognized so that the optical pointing device is easily used in a narrow space in the X-axis direction. The search range of the image sensor 21-1 is reset together with a rotation mapping function of rotating the X- and Y-axis values of the output of the motion value calculator 22 by 90° or −90°. However, as the optical pointing device has a variety of additional functions, the optical pointing device may be used upside-down. In this case, the optical pointing device may calculate the motion value by allowing a user to hold the optical pointing device and move an object, such as his or her finger, instead of calculating the motion value while moving the optical pointing device on a worktable.

When the optical pointing device is used upside-down, the moving direction of the object does not match with the motion information in the X- or Y-axis direction output from the optical pointing device depending on the direction that the optical pointing device is facing.

### SUMMARY OF THE INVENTION

The present invention provides an optical pointing device for outputting the same motion information as a motion of an object when the optical pointing device is used upside-down.

The present invention also provides a method for calculating a motion value in the above optical pointing device.

According to an aspect of the present invention, an optical pointing device comprises: a light source for emitting light; a mode identifier for outputting an upside-down mode signal when the optical pointing device is used upside-down; an image sensor for receiving reflected light from an object and obtaining image information of the object; a converter for converting the image information into digital image data; a basic motion value calculator for outputting a basic motion value corresponding to a motion of the optical pointing device using the image data; and a motion value converter for receiving the basic motion value and outputting a mirror motion value corresponding to the motion of the object in response to the upside-down mode signal.

The basic motion value calculator may output a basic motion value corresponding to a motion of the optical pointing device using image data obtained during a previous sampling period and image data obtained during a current sampling period.

The motion value converter may comprise a mirror unit for inverting a Y value of the basic motion value to correspond to the motion of the object in response to the upside-down mode signal, and outputting the mirror motion value.

The mode identifier may further comprise an upside-down orientation sensor for sensing an upside-down orientation of the optical pointing device.

The upside-down orientation sensor may comprise a first upside-down orientation sensor for sensing the optical pointing device being turned upside-down with reference to a Y-axis and outputting a first upside-down mode signal; and a second upside-down orientation sensor for sensing the optical pointing device being turned upside-down with reference to an X-axis and outputting a second upside-down mode signal.

The motion value converter may comprise a first mirror unit for inverting a Y value of the basic motion value to correspond to the motion of the object in response to the first upside-down mode signal, and outputting a first mirror motion value; and a second mirror unit for inverting an X value of the basic motion value to correspond to the motion of the object in response to the second upside-down mode signal, and outputting a second mirror motion value.

The mode identifier may further output a rotation mode signal corresponding to a layout of the light source and the image sensor.

The motion value converter may further comprise a rotation unit for interchanging an X value and a Y value of the basic motion value and outputting a rotation motion value in response to the rotation mode signal.

According to another aspect of the present invention, a method for calculating a motion value in an optical pointing device comprises: emitting light; outputting an upside-down mode signal when the optical pointing device is upside-down; receiving reflected light from an object and obtaining image information of the object; converting the image information into digital image data; outputting a basic motion value corresponding to a motion of the optical pointing device using the image data; and outputting a mirror motion value in response to the upside-down mode signal and the basic motion value.

The outputting of a basic motion value may comprise outputting a basic motion value corresponding to the motion of the optical pointing device using image data obtained during a previous sampling period and image data obtained during a current sampling period.

The outputting of an upside-down mode signal may further comprise sensing an upside-down orientation of the optical pointing device.

The sensing of an upside-down orientation may comprise sensing the optical pointing device being turned upside-down with reference to a Y-axis and outputting a first upside-down mode signal.

The outputting of a mirror motion value may comprise inverting a Y value of the basic motion value to correspond to the motion of the object in response to the first upside-down mode signal, and outputting the mirror motion value.

The sensing of an upside-down orientation may comprise sensing the optical pointing device being turned upside-down with reference to an X-axis and outputting a second upside-down mode signal.

The outputting of a mirror motion value may comprise inverting an X value of the basic motion value to correspond to the motion of the object in response to the second upside-down mode signal, and outputting the mirror motion value.

The method may further comprise outputting a rotation mode signal corresponding to a layout of the light source and the image sensor. The method may further comprise interchanging an X value and a Y value and outputting a rotation motion value in response to the rotation mode signal.

### BRIEF DESCRIPTION OF THE DRAWINGS

The above and other features of the present invention will be described in reference to certain exemplary embodiments thereof with reference to the attached drawings in which:

FIG. 1 illustrates an optical mouse that is one example of a typical optical pointing device;

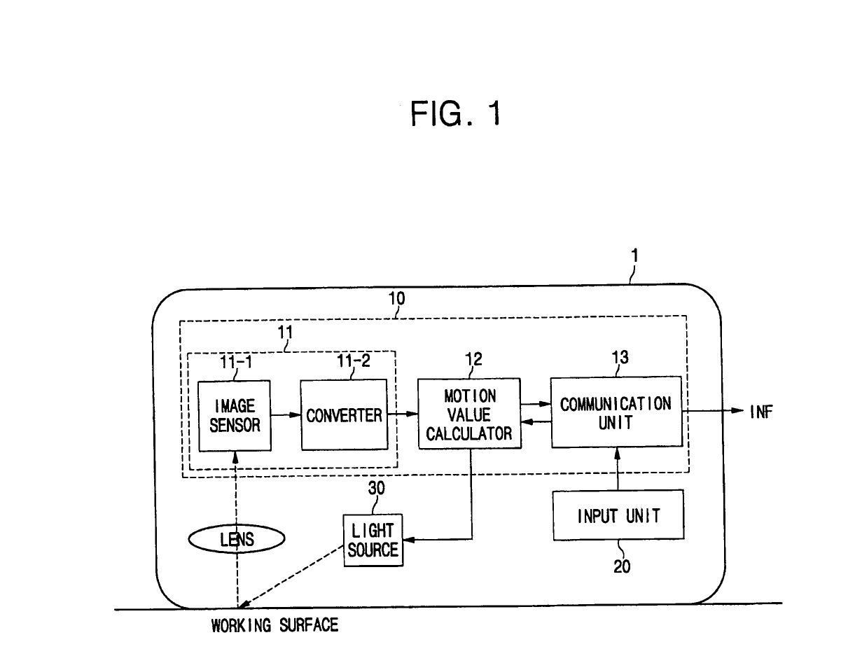

FIG. 2 is a block diagram illustrating a conventional optical pointing device;

FIG. 3 is a first method for setting a motion search range depending on a layout of an image sensor and a light source according to the conventional optical pointing device;

FIG. 4 is a second method for setting a motion search range depending on a layout of an image sensor and a light source according to the conventional optical pointing device;

FIG. 5 illustrates a method for turning an optical pointing device upside-down;

FIG. 6 is a partial block diagram illustrating an optical pointing device according to the present invention;

FIG. 7 is a partial block diagram illustrating the motion value calculator of FIG. 6;

FIG. 8 illustrates frames obtained by an image sensor;

FIG. 9 illustrates a method for calculating a motion value in a basic motion value calculator of FIG. 7 using frames of FIG. 8; and

FIG. 10 illustrates an example of an optical pointing device according to the present invention.

### DETAILED DESCRIPTION OF EXEMPLARY EMBODIMENTS

Hereinafter, an optical pointing device and a method for calculating a motion value in the optical pointing device according to the present invention will be described with reference to the accompanying drawings.

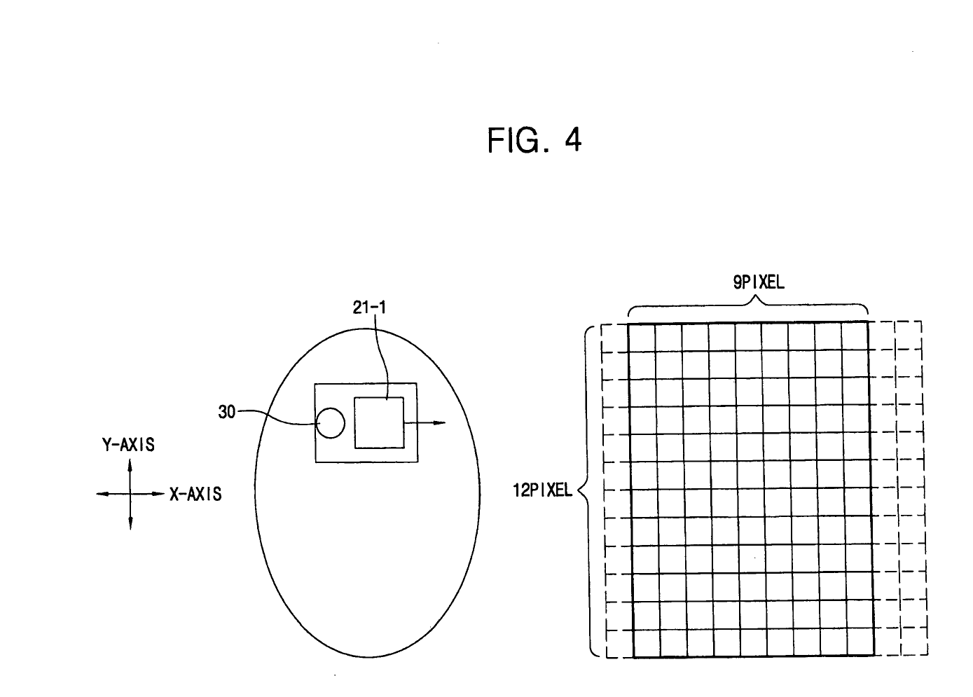

In the present invention, a scheme of calculating a motion value while moving the optical pointing device on a worktable is referred to as a normal mode, and a scheme of calculating a motion value while moving an object while an optical pointing device is upside-down is referred to as an upside-down mode. And, a scheme of calculating a motion value while interchanging an X-axis and a Y-axis of the optical pointing device and recognizing the X-axis and the Y-axis as in FIG. 4 is referred to as a rotation mode.

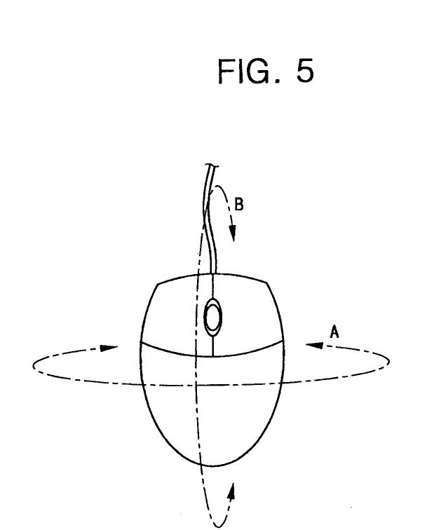

FIG. 5 illustrates a method for turning an optical pointing device upside-down.

In the upside-down mode in which the optical pointing device is and used upside-down, when the optical pointing device is turned upside-down with reference to a Y-axis in a direction A of FIG. 5, motion information output from the optical pointing device match with each other for a horizontal motion of the object. However, motion information output from the optical pointing device are opposite from each other for a vertical motion of the object. That is, when the object moves down, the motion information output from the optical pointing device indicates that the object moves up, and when the object moves up, the motion information output from the optical pointing device indicates that the object moves down.

On the other hand, when the optical pointing device is turned upside-down with reference to an X-axis in a direction B of FIG. 5, motion information output from the optical pointing device match with each other for a vertical motion of the object. However, the motion information output from the optical pointing device are opposite from each other for a horizontal motion of the object. That is, when the object moves to the left, the motion information output from the optical pointing device indicates that the object moves to the right, and when the object moves to the right, the motion information output from the optical pointing device indicates that the object moves to the left.

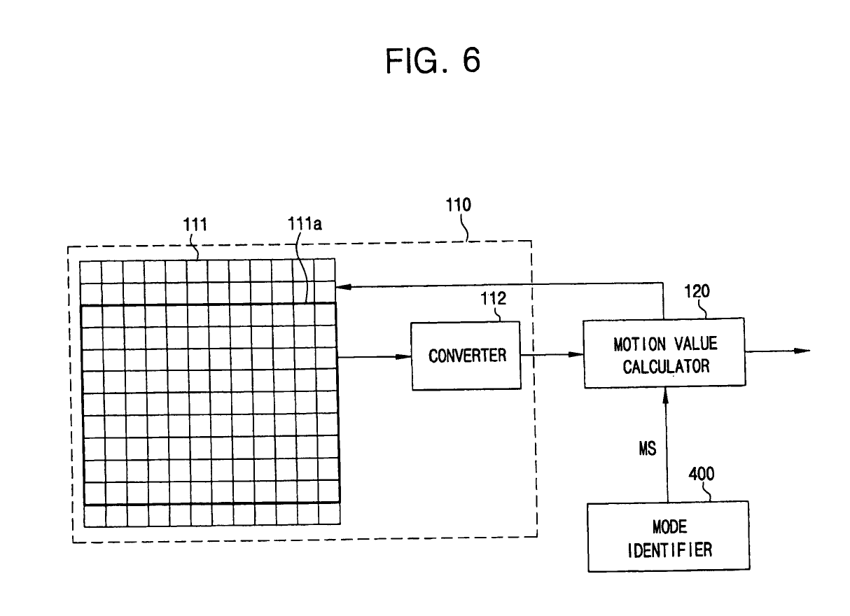

FIG. 6 is a partial block diagram illustrating an optical pointing device according to the present invention.

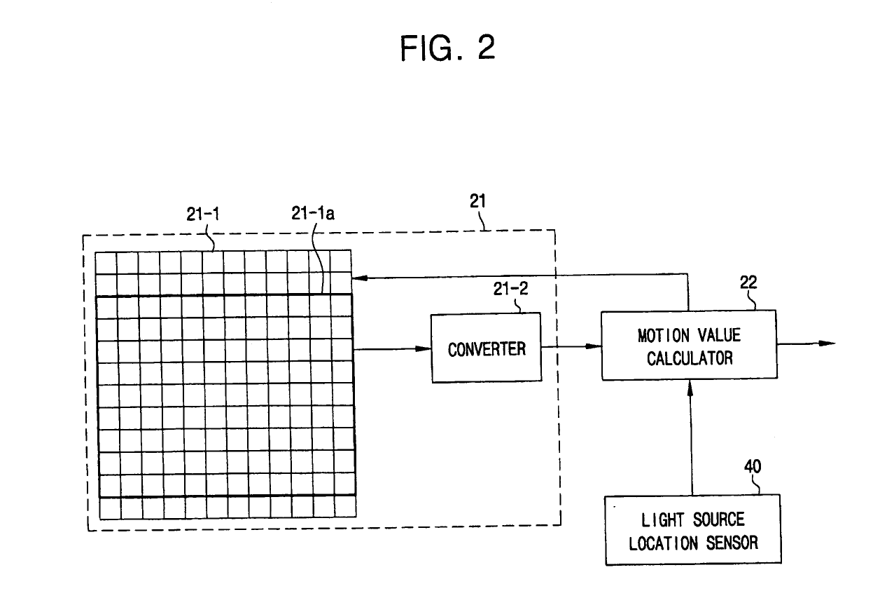

Referring to FIG. 6, an image data output unit 110 includes an image sensor 111 and a converter 112, like the image data output unit 11 of FIG. 2. The image sensor 111 includes a plurality of pixels, and activates only pixels corresponding to a specific area 111a in response to column and row select signals and a pixel control signal from a motion value calculator 120. The image sensor 111 senses image information through the activated pixels, generates an analog signal corresponding to the sensed image information, and outputs the same to the converter 112.

The converter 112 converts the analog signals applied from the plurality of pixels of the image sensor 111 into digital data and outputs the digital data to the motion value calculator 120 as image data.

A mode identifier 400 identifies a mode corresponding to a state of the optical pointing device and outputs a mode signal MS corresponding to the mode to the motion value calculator 120.

The motion value calculator 120 receives the image data from the converter 112 and the mode signal MS from the mode identifier 400, and calculates and outputs a motion value corresponding to the mode. The motion value calculator 120 determines a motion search range in response to the mode signal MS, generates column and row select signals and a pixel control signal for activating the specific area 111a of the image sensor corresponding to the determined motion search range, and sends the same to the image sensor 111, as in FIG. 2.

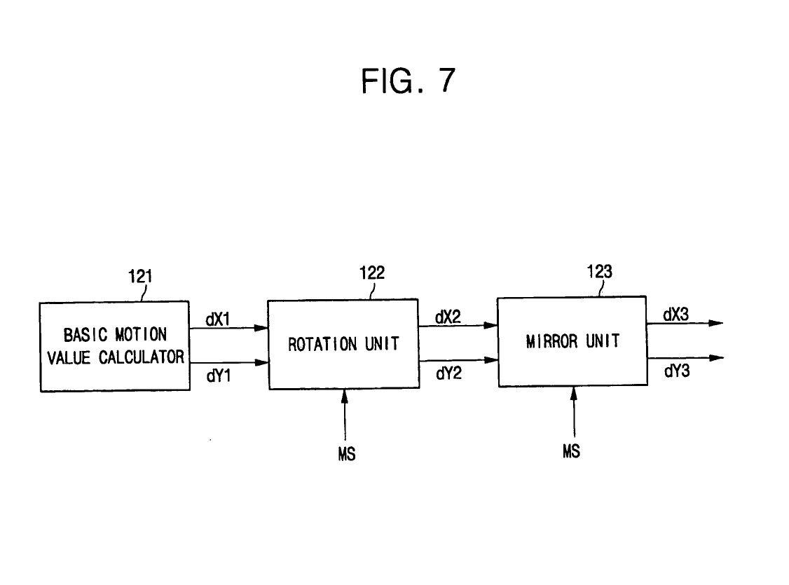

FIG. 7 is a partial block diagram illustrating the motion value calculator of FIG. 6.

Referring to FIG. 7, the motion value calculator 120 includes a basic motion value calculator 121, a rotation unit 122, and a mirror unit 123. The basic motion value calculator 121 calculates a motion value in the same way of calculating a motion value in a typical optical pointing device, and outputs a first X value dX1 and a first Y value dY1. The first X value dX1 indicates the number of pixels by which the optical pointing device or the object has moved in the X-axis direction, and the first Y value dY1 indicates the number of pixels by which the optical pointing device or the object has moved in the Y-axis direction.

The rotation unit 122 and the mirror unit 123 are activated by the mode signal MS. When the mode signal MS from the mode identifier 400 is applied as a rotation mode signal, the rotation unit 122 is activated, and when the mode signal MS is applied as an upside-down mode signal, the mirror unit 123 is activated.

The rotation unit 122 receives the first X value dX1 and the first Y value dY1 from the basic motion value calculator 121, and crudely outputs the first X value dX1 and the first Y value dY1 as a second X value dX2 and a second Y value dY2 when the mode signal MS from the mode identifier 123 is not the rotation mode signal. However, when the mode signal MS is applied as the rotation mode signal, the rotation unit 122 outputs the first X value dX1 as the second Y value dY2 and the first Y value dY1 as the second X value dX2. That is, the rotation unit 122 interchanges the first X value dX1 and the first Y value dY1 and outputs the values as the second Y value dY2 and the second X value dX2.

In an A-direction upside-down mode in which the optical pointing device is turned upside-down with reference to the Y-axis, the mirror unit 123 receives the second X value dX2 and the second Y value dY2 from the rotation unit 122, and crudely outputs the second X value dX2 and the second Y value dY2 as a third X value dX3 and a third Y value dY3 when the mode signal MS from the mode identifier 123 is not the upside-down mode signal. When the mode signal MS is applied as the upside-down mode signal, the mirror unit 123 crudely outputs the second X value dX2 as the third X value dX3 and inverts the second Y value dY2 to output the second inverted Y value −dY2 as the third Y value dY3. That is, the value in the X-axis direction is kept unchanged and only the value in the Y-axis direction is inverted and output.

In a B-direction upside-down mode in which the optical pointing device is turned upside-down with reference to the X-axis, the mirror unit 123 crudely outputs the second Y value dY2 as the third Y value dY3 when the mode signal MS is applied as the upside-down mode signal, and inverts the second X value dX2 to output the second inverted X value −dX2 as the third X value dX3. That is, the value in the Y-axis direction is kept unchanged, and only the value in the X-axis direction is inverted and output.

Thus, the motion value calculator 120 shown in FIG. 7 calculates and outputs the motion value corresponding to the mode based on the image data from the image data output unit 110 in response to the mode signal MS from the mode identifier 400. When the optical pointing device is in the rotation mode, the motion value calculator 120 calculates the motion value (dX1, dY1) like a typical optical pointing device, interchanges an X value dX1 and a Y value dY1 of the motion value (dX1, dY1), and outputs the rotated motion value (dY1, dX2). When the optical pointing device is in the upside-down mode, the motion value calculator 120 calculates the motion value (dX1, dY1) like a typical optical pointing device. And, the motion value calculator 120 inverts the Y value dY1 of the motion value (dX1, dY1) to output the upside-down motion value (dX1, −dY1) or inverts the X value dX1 of the motion value (dX1, dY1) to output the upside-down motion value (−dX1, dY1), depending on the optical pointing device upside-down orientation.

The rotation unit 122 and the mirror unit 123 may be simultaneously activated. When the rotation unit 122 and the mirror unit 123 are simultaneously activated, the rotation unit 122 interchanges the first X value dX1 and the first Y value dY1, and outputs the rotated motion value (dY1, dX1) as the second X value dX2 and the second Y value dY2, respectively. In the case of an A-direction orientation, the mirror unit 123 inverts the second Y value dY2 among the second X value dX2 and the second Y value dY2, and outputs the upside-down motion value (dX2, −dY2) as the third X value dX3 and the third Y value dY3, respectively. In the case of a B-direction orientation, the mirror unit 123 inverts the second X value dX2 among the second X value dX2 and the second Y value dY2 and outputs the upside-down motion value (−dX2, dY2) as the third X value dX3 and the third Y value dY3. As a result, where the motion value (dX3, dY3) from the optical pointing device is represented by the first X value dX1 and the first Y value dY1, which are motion values of a typical optical pointing device, the motion value (dX3, dY3) is output as the motion value (dY1, −dX1) in the case of the A-direction orientation where the device is turned upside-down with reference to the Y-axis and as the motion value (−dY1, dX1) in the case of the B-direction orientation where the device is turned upside-down with reference to the X-axis.

The mirror unit 123 may include a first mirror unit and a second mirror unit to cope with both the A-direction orientation and the B-direction orientation, in which the first mirror unit may output a motion value corresponding to the A-direction orientation and the second mirror unit may output a motion value corresponding to the B-direction orientation.

A user can set the optical pointing device to various modes and select and use a suitable mode, when required, by the motion value calculator 120 including both the rotation unit 122 and the mirror unit 123, as well as the basic motion value calculator 121, as described above.

The motion value calculator 120 may further include a select signal generator (not shown) for generating the column and row select signals and the pixel control signal when the mode signal is the rotation mode signal.

In FIG. 7, the rotation unit 122 and the mirror unit 123 may interchange their location as the user desires.

Although the rotation unit 122 and the mirror unit 123 have been described as being included in the motion value calculator 120, they may be included at an output side of the image sensor 111, at an output side of the converter 112, or in the communication unit. However, it is desirable that the rotation unit 122 and the mirror unit 123 are included after the basic motion value calculator 121 for easy calculation of the rotated motion value, a vertically inverted motion value or a horizontally inverted motion value.

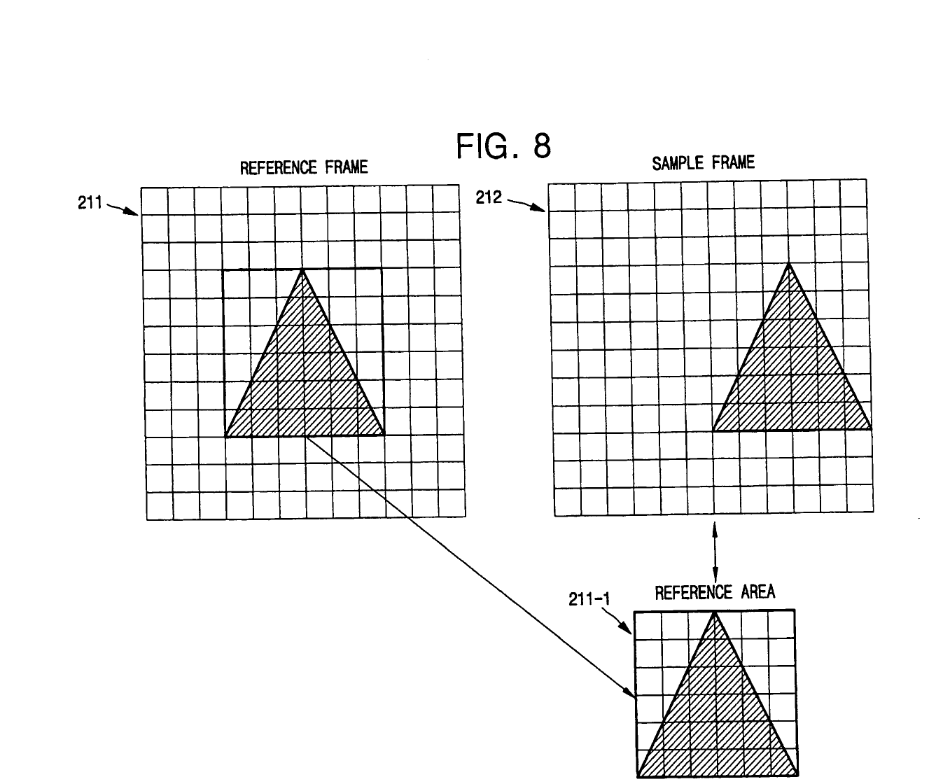

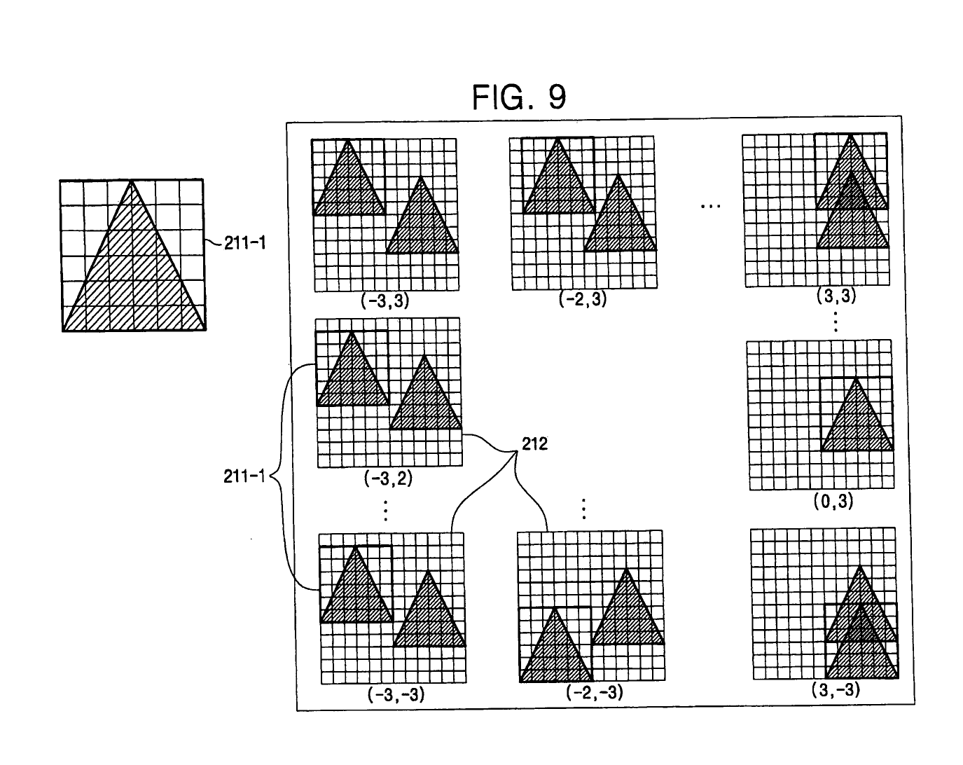

FIG. 8 illustrates frames obtained by the image sensor 111 in order to describe operation of the basic motion value calculator 121 of FIG. 7, and FIG. 9 illustrates a method for calculating the motion value in the basic motion value calculator of FIG. 7 using frames of FIG. 8.

In FIG. 8, a reference frame 211 is image information obtained by the image sensor 111 during a previous sampling period of the optical pointing device, and a sample frame 212 is image information obtained by the image sensor 111 during a current sampling period.

When the optical pointing device is to calculate a motion distance during the current sampling period, the optical pointing device sets the frame obtained during the previous sampling period as the reference frame 211, sets a predetermined area of the reference frame 211 as a reference area 211-1, and sets the frame 212 obtained during the current sampling period as the sample frame.

As shown in FIG. 9, a correlation between the reference area 211-1 and the sample frame 212 is calculated while scanning the reference area 211-1 from a left upper end (−3, 3) of the sample frame 212 to a right lower end (3, −3) on a pixel-by-pixel basis in a zigzag manner.

A location of the sample frame 212 having the highest correlation is obtained, and the motion value of the optical pointing device is calculated from the obtained location of the sample frame 212.

In FIG. 9, the sample frame 212 has the highest correlation with the reference area 211-1 at location (3, 0). Here, since the optical pointing device has moved by 3 pixels on the X-axis, the basic motion value calculator 121 of FIG. 7 outputs the first X value dX1 and the first Y value dY1 as the motion value (3, 0).

While the center area of the reference frame 211 in FIG. 8 has been set as the reference area 211-1, any other area may be set as the reference area 211-1. However, when the center area of the reference frame 211 is set as the reference area 211-1, it is easy to calculate the motion value irrespective of the moving direction of the optical pointing device.

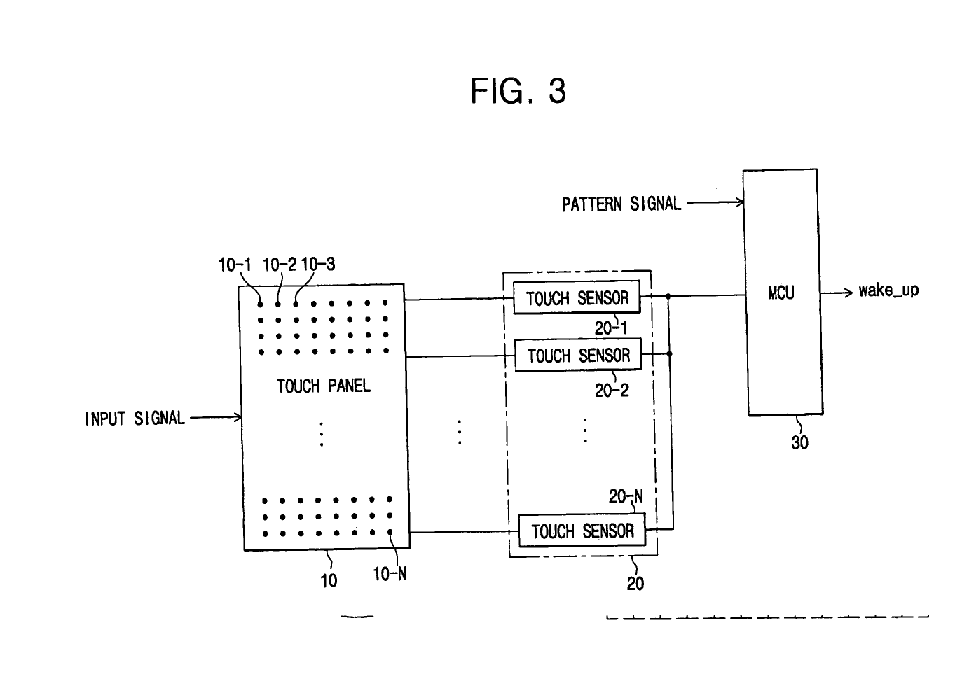

When the optical pointing device is in a specific mode, such as the rotation mode, as illustrated in FIGS. 3 and 4, the size of the sample frame 212 may be limited.

A characteristic of the optical pointing device according to the present invention is to support the upside-down mode. However, in order to apply the upside-down mode, the mode identifier 400 must be able to determine whether the optical pointing device is currently in the upside-down mode.

The optical pointing device may identify the mode in various ways. The simplest way of identifying the mode is for the optical pointing device to have a mode switch. That is, a user sets the normal mode, the rotation mode, and the upside-down mode by operating the switch. Since the mode is set depending on a state of the switch, the mode identifier 400 is unnecessary when the switch is configured to output a mode signal corresponding to each mode.

Alternative to the way of setting the mode using the switch, the mode may be set depending on the layout of the light source and the image sensor as shown in FIGS. 3 and 4. Also, a method for preventing glare caused by a light source of an optical mouse as disclosed in Korean Patent No. 0620950 (hereinafter, “cited reference”) may be applied to the optical pointing device of the present invention. In the cited reference, a determination is made as to whether the optical mouse is apart from a working surface, in order to prevent glare when the optical mouse is upside-down. In the present invention in which the optical pointing device is used upside-down in the upside-down mode, the mode can be identified in a similar way to the cited reference.

In the cited reference, the determination as to whether the optical mouse is apart from the working surface is made by a method of identifying a state of the optical mouse using a code generator, a sensor, and a code parser; a method of identifying a state of the optical mouse using a push button; a method of identifying a state of the optical mouse using an upper cover and a bottom cover; and a method of identifying a state of the optical mouse using a light emitting diode and a sensor.

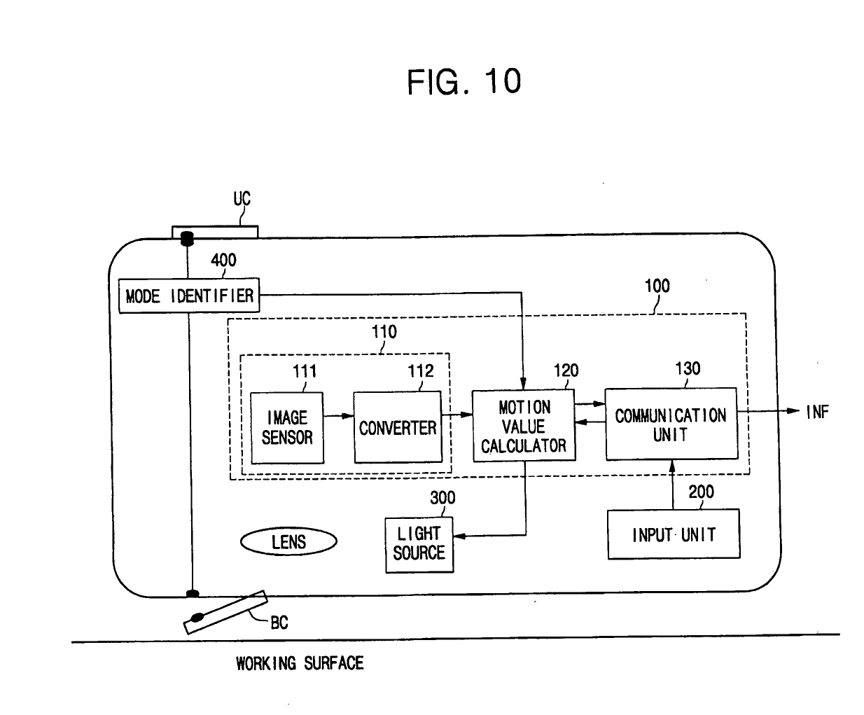

FIG. 10 illustrates an example of an optical pointing device according to the present invention. Here, the method of identifying a state of an optical mouse using an upper cover UC and a bottom cover BC as described in the cited reference is applied to identify the mode of the optical pointing device.

Referring to FIG. 10, the optical pointing device includes a controller 100, an input unit 200, a light source 300, an upper cover UC, a bottom cover BC, and a mode identifier 400. The controller 100 includes an image data output unit 110 including an image sensor 111 and a converter 112; a motion value calculator 120; and a communication unit 130. The lens delivers reflected light from a working surface to the image sensor 111.

The controller 100 senses an image from the working surface and calculates a motion value corresponding to the mode in response to a mode signal MS. The image data output unit 110 senses the image of the working surface and outputs image data for the sensed image. The controller 100 outputs motion information INF to an external device, such as a computer, according to an input signal from the input unit 200 and the calculated motion value.

The image sensor 111 of the image data output unit 110 receives the reflected light from the working surface via the lens to sense image information, and outputs an analog signal corresponding to the sensed image information. The converter 112 converts the analog signal from the image sensor 111 into digital image data and outputs the digital image data as the image data.

The motion value calculator 120 receives a mode signal MS to identify the mode of the optical pointing device, and calculates and outputs a motion value using the image data input from the converter 112 in response to the identified mode.

The communication unit 130 outputs information signal input from the input unit 200 to the motion value calculator 120, and outputs the motion information INF to the external device, such as a computer, in response to the motion value input from the motion value calculator 120 and the input signal input from the input unit 200.

The upper cover UC is apart from a main body of the optical pointing device when the optical pointing device is upside-down, and the bottom cover BC is apart from the main body of the optical pointing device when the optical pointing device is apart from the working surface. The mode identifier 400 outputs the mode signal MS depending on whether the upper cover UC or the bottom cover BC is apart from the main body of the optical pointing device.

That is, when the optical pointing device shown in FIG. 10 is apart from the working surface, either the upper cover UC or the bottom cover BC is apart from the main body of the optical pointing device. Thus, the mode identifier 400 determines whether either the upper cover UC or the bottom cover BC is apart from the main body of the optical pointing device and outputs the mode signal MS according to the determination result, so that a determination is made as to whether the optical pointing device is upside-down.

Although the optical pointing device in FIG. 10 includes the upper cover UC and the bottom cover BC so that the mode identifier identifies the upside-down mode, it will be easily appreciated that the upside-down mode of the optical pointing device can be actually identified even with the upper cover UC.

It will also be easily appreciated that another embodiment of the cited reference may be applied to the present invention.

Where the optical pointing device uses the upside-down mode, it is necessary to discriminate between the A-direction orientation and the B-direction orientation. However, since using the optical pointing device upside-down mainly occurs when the optical pointing device has an additional function, the upside-down orientation of the optical pointing device may be determined in advance upon designing the optical pointing device or a separate selection method such as using the mode switch may be provided, depending on the additional function. For example, a sensing device, such as a contact sensor, is additionally provided at a specific location of the optical pointing device for sensing the upside-down orientation. That is, since the user is brought into contact with a different portion of the optical pointing device depending on the upside-down orientation, the upside-down orientation can be determined by determining whether a contact with the contact sensor is made. It will be easily appreciated that the contact sensor may be used for determining whether the optical pointing device is upside-down.

Thus, the optical pointing device and the method for calculating a motion value in the optical pointing device according to the present invention provide the rotation mode and the upside-down mode, in addition to the normal mode, so that the optical pointing device is used in various situations and the optical pointing device is used upside-down.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. An optical pointing device comprising:
a light source emitting light;
a mode identifier outputting an upside-down mode signal when the optical pointing device is used upside-down;
an image sensor receiving reflected light from an object and obtaining image information of the object;
a converter converting the image information into digital data and outputting the digital data as image data;
a basic motion value calculator calculating a basic motion value corresponding to a motion of the optical pointing device using the image data; and
a motion value converter receiving the basic motion value and converting the basic motion value into a mirror motion value corresponding to the motion of the object in response to the upside-down mode signal.

2. The device of claim 1, wherein the basic motion value calculator calculates a basic motion value corresponding to a motion of the optical pointing device using image data obtained during a previous sampling period and image data obtained during a current sampling period.

3. The device of claim 1, wherein the motion value converter comprises a mirror unit inverting a Y value of the basic motion value to correspond to the motion of the object in response to the upside-down mode signal, and outputting the mirror motion value.

4. The device of claim 3, wherein the mode identifier further outputs a rotation mode signal corresponding to a layout of the light source and the image sensor.

5. The device of claim 4, wherein the motion value converter further comprises a rotation unit for interchanging an X value and a Y value of the basic motion value and outputting a rotation motion value in response to the rotation mode signal.

6. The device of claim 1, wherein the motion value converter comprises a mirror unit inverting an X value of the basic motion value to correspond to the motion of the object in response to the upside-down mode signal, and outputting the mirror motion value.

7. The device of claim 6, wherein the mode identifier further outputs a rotation mode signal corresponding to a layout of the light source and the image sensor.

8. The device of claim 7, wherein the motion value converter further comprises a rotation unit interchanging an X value and a Y value of the basic motion value and outputting a rotation motion value in response to the rotation mode signal.

9. The device of claim 1, wherein the mode identifier further comprises an upside-down orientation sensor sensing an upside-down orientation of the optical pointing device.

10. The device of claim 9, wherein the upside-down orientation sensor comprises:
a first upside-down orientation sensor sensing the optical pointing device being turned upside-down with reference to a Y-axis and outputting a first upside-down mode signal; and
a second upside-down orientation sensor sensing the optical pointing device being turned upside-down with reference to an X-axis and outputting a second upside-down mode signal.

11. The device of claim 10, wherein the motion value converter comprises:
a first mirror unit inverting a Y value of the basic motion value to correspond to the motion of the object in response to the first upside-down mode signal, and outputting a first mirror motion value; and
a second mirror unit inverting an X value of the basic motion value to correspond to the motion of the object in response to the second upside-down mode signal, and outputting a second mirror motion value.

12. The device of claim 11, wherein the mode identifier further outputs a rotation mode signal corresponding to a layout of the light source and the image sensor.

13. The device of claim 12, wherein the motion value converter further comprises a rotation unit interchanging an X value and a Y value of the basic motion value and outputting a rotation motion value in response to the rotation mode signal.

14. The device of claim 1, wherein the mode identifier comprises a switch selecting each mode.

15. The device of claim 1, wherein the optical pointing device further comprises an upper cover disposed on the top of the optical pointing device for setting the upside-down mode.

16. The device of claim 15, wherein the optical pointing device further comprises a bottom cover disposed on the bottom of the optical pointing device.

17. The device of claim 1, further comprising:
an input unit outputting an input signal in response to an external command; and
a communication unit outputting the motion information to the exterior in response to the input signal and the output of the motion value calculator.

18. A method for calculating a motion value in an optical pointing device, comprising:
emitting light;
outputting an upside-down mode signal when the optical pointing device is upside-down;
receiving reflected light from an object and obtaining image information of the object;
converting the image information into digital data as image data;
calculating a basic motion value corresponding to a motion of the optical pointing device using the image data; and
converting the basic motion value into a mirror motion value corresponding to the motion of the object in response to the upside-down mode signal.

19. The method of claim 18, wherein the calculating of the basic motion value comprises calculating a basic motion value corresponding to the motion of the optical pointing device using image data obtained during a previous sampling period and image data obtained during a current sampling period.

20. The method of claim 19, wherein the outputting of the upside-down mode signal further comprises sensing an upside-down orientation of the optical pointing device.

21. The method of claim 20, wherein the sensing of the upside-down orientation comprises sensing the optical pointing device being turned upside-down with reference to a Y-axis and outputting a first upside-down mode signal.

22. The method of claim 21, wherein the converting the basic motion value comprises inverting a Y value of the basic motion value to correspond to the motion of the object in response to the first upside-down mode signal, and outputting the mirror motion value.

23. The method of claim 22, further comprising outputting a rotation mode signal corresponding to a layout of the light source and the image sensor.

24. The method of claim 23, further comprising interchanging an X value and a Y value and outputting a rotation motion value in response to the rotation mode signal.

25. The method of claim 20, wherein the sensing of the upside-down orientation comprises sensing the optical pointing device being turned upside-down with reference to an X-axis and outputting a second upside-down mode signal.

26. The method of claim 25, wherein the converting the basic motion value comprises inverting an X value of the basic motion value to correspond to the motion of the object in response to the second upside-down mode signal, and outputting the mirror motion value.

27. The method of claim 26, further comprising outputting a rotation mode signal corresponding to a layout of the light source and the image sensor.

28. The method of claim 27, further comprising interchanging an X value and a Y value and outputting a rotation motion value in response to the rotation mode signal.
